(19) United States
(12) Patent Application Publication
(10) Pub. No.: US 2005/0151841 A1
(43) Pub. Date: Jul. 14, 2005

(54) Automated inspection and processing system

(76) Inventors: Bruce N. Nelson, West Newton, MA (US); Paul Slebodnick, Springfield, VA (US); Edward John Lemieux, Key West, FL (US); Matt Krupa, Key West, FL (US); William Singleton, Newton, MA (US)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 10/508,850

(22) PCT Filed: Mar. 24, 2003
(86) PCT No.: PCT/US03/08981

Related U.S. Application Data
(60) Provisional application No. 60/367,221, filed on Mar. 25, 2002.

(51) Int. Cl. H04N 7/18

(52) U.S. Cl. 348/82; 348/83; 348/84

(57) ABSTRACT

An automated inspection system is provided wherein an inspection of a surface and the processing of inspection data acquired from the surface can be performed with limited or no operator involvement and wherein a high level of consistency can be s maintained between each inspection and between each processing of inspection data across multiple inspections of the surface.

### RELATED APPLICATIONS

This application claims priority to U.S. provisional patent application Ser. No. 60/367,221, entitled “AUTOMATED INSPECTION AND PROCESSING SYSTEM,” filed Mar. 25, 2002 by Nelson et al., which is incorporated herein by reference in its entirety.

### U.S. GOVERNMENT RIGHTS IN THE INVENTION

This invention was made with Government support under Contract No. N00173-00-C-2096. The Government has certain rights in this invention.

### FIELD OF THE INVENTION

The present invention relates generally to inspection systems and, more particularly, to video inspections systems for containers, tanks, pipelines, or any of various other industrial surfaces that may require routine and/or periodic inspections.

### BACKGROUND OF THE INVENTION

Many industrial and commercial applications require surface inspections to evaluate integrity, detect flaws or the presence of certain materials, and/or determine the extent of damage incurred during use such as exposure to corrosive and/or dangerous materials. For example, line-haul and long-haul trucks, freight rails and ocean going vessels are routinely employed to transport tanks containing gasoline, oil, natural gas, industrial chemicals, etc. Ballast and other shipboard tanks may be filled and drained of water to aid in the stabilization of ships and perform other functions necessary for the operation of many ocean going vessels. Various pipelines may be employed to convey liquids, hazardous fluids, waste material and/or sewage, etc.

Many such surfaces may need to be regularly inspected to facilitate detection of corrosion, cracks, material build-up and/or other breaches to the integrity of the surface that may cause the surface to leak, function improperly, and/or fail altogether. Regular and/or periodic inspection may allow preventative measures to be taken to ensure that the surface remains in a condition sufficient to carry out its intended function.

The term “inspection surface” or “surface of interest” will be used herein to describe any surface of which an inspection may be desired, including, but not limited to, tanks, pipelines, industrial facilities and/or equipment, etc. The term “tank” applies generally to any volume used for holding, transporting and/or storing materials including, but not limited to, ballast and/or shipboard tanks, freight containers, oil tankers, nuclear reactors, waste tanks, storage facilities, etc.

Inspection of various surfaces, for example, the inside surface of a tank, often requires a trained and/or certified inspector to properly assess the condition of a tank, identify potential problems and/or surface anomalies or to determine whether the surface is safe for continued operation and use. Conventional systems often require a physical inspection of the surface. The term “physical inspection” refers generally to any inspection or examination of a surface of interest wherein the individual carrying out the inspection is physically proximate to and capable of directly viewing the surface.

However, an inspection surface may have come into contact with dangerous liquids, gases or radiation levels. Significant and often time-consuming precautions and procedures must be enacted prior to an inspection to insure that the environment of the surface of interest has been properly detoxified. Accordingly, a surface, whether it be a container, a pipeline or a storage facility, may be inoperable during both preparation procedures and the actual inspection of the surface. In addition, many exemplary surfaces may be difficult to access, dark and often dangerous to navigate. These conditions make physical inspections a time-consuming, inconvenient and cumbersome task that may present a risk of injury to an inspector.

Furthermore, it is often difficult logistically to schedule an inspector to be present for an inspection. In cases where an inspection surface is involved in transportation, shipping or part of other itinerant operations, an inspector may not be available at any given locale when a surface is due for, or it is desired to perform an inspection. Scheduling and arranging for an inspector to be present for a physical examination often results in considerable expense, loss of time, function, and/or loss of revenue.

### SUMMARY OF THE INVENTION

Applicant has identified and appreciated that various automation techniques may benefit inspection of various surfaces that may require routine or periodic inspection, may include toxic or dangerous environments, and/or are inconvenient or hazardous to access or navigate. It should be appreciated that the automated inspection and processing methods and apparatus of the present invention may be employed in connection with any type of surface including, but not limited to, various transport and storage containers, tanks, pipelines, industrial process rooms, vaults, reactors, etc.

A general underlying concept of various embodiments of the present invention derives from Applicant's appreciation that a sequence of camera control parameters describing a set of camera actions corresponding to an inspection sequence of a particular surface of interest can be applied to an inspection system on any subsequent inspection of the surface such that consistent inspection sequences can be automatically obtained each time the sequence of camera control parameters is applied to the inspection system.

One embodiment according to the present invention includes a method of repeating an inspection of a surface of interest in an inspection system including a control unit coupled to a camera. The method comprises acts of providing a sequence of camera control parameters corresponding to first inspection data of the surface of interest from the control unit to the camera, and acquiring at least one second inspection data of the surface of interest according to the sequence of camera control parameters.

Another embodiment according to the present invention includes an inspection apparatus adapted to automatically acquire inspection data of a surface of interest. The inspection apparatus comprises data collection equipment including a camera capable of acquiring at least one image of the surface of interest, and a control unit coupled to the data collection equipment, the control unit configured to provide a sequence of camera control parameters corresponding to first inspection data of the surface of interest to the camera to acquire at least one second inspection data of the surface of interest.

Another embodiment according to the present invention includes a method of inspecting a surface of interest comprising acts of automatically applying a sequence of camera control parameters to acquire a sequence of images of the surface of interest, and automatically processing the sequence of images to evaluate the surface of interest.

Another embodiment according to the present invention includes an automated inspection apparatus comprising means for automatically acquiring at least one sequence of images of a surface of interest from a sequence of camera control parameters, and means for automatically processing the at least one sequence of images to automatically evaluate the surface of interest.

### BRIEF DESCRIPTION OF THE DRAWINGS

FIG. 1 illustrates one embodiment of an automated inspection system according to the present invention;

FIG. 2 illustrates one embodiment of a camera coordinate reference frame conventionally used to describe the external pose of a camera;

FIG. 3 illustrates another embodiment of an automated inspection system according to the present invention including a stalk adapted to inspect a volume;

FIG. 4 illustrates another embodiment of an automated inspection system according to the present invention adapted to conduct an inspection in the presence of a fluid;

FIG. 5 illustrates a block diagram of various components included in one embodiment of an automated inspection system according to the present invention;

FIG. 6 illustrates one method of generating and storing a sequence of camera control parameters according to the present invention for use in subsequent automatic inspections of a surface of interest;

FIG. 7 illustrates one method of performing an automatic inspection of a surface of interest according to the present invention by providing a sequence of camera control parameters to a camera of the inspection system;

FIG. 8 illustrates a block diagram of various components of another embodiment of an automated inspection system according to the present invention including a program configured to automatically analyze a sequence of images;

FIG. 9 illustrates one method of automatically analyzing a sequence of images according to the present invention;

FIG. 10 illustrates a detailed description of one method of automatically determining the amount of subject matter of interest present in a sequence of images according to the present invention;

FIG. 11 illustrates one aspect of the method illustrated in FIG. 10;

FIG. 12 illustrates another aspect of the method illustrated in FIG. 10; and

FIG. 13 illustrates another aspect of the method illustrated in FIG. 10.

### DETAILED DESCRIPTION

Video inspection systems may offer significant advantages over physical inspections of various surfaces of interest, often overcoming the difficulties and dangers associated with the physical inspection. Video cameras have been employed in various video inspection systems to supplant physical inspections. Video inspection systems are typically mounted to a surface to acquire video information about the surface of interest. An inspector may then inspect a surface by viewing a video sequence acquired of the surface of interest rather than directly viewing the surface itself. Such manual inspections may reduce the costs associated with inspecting a surface and may reduce or eliminate many of the hazards and/or risks involved in physical inspections.

The term “manual inspection” refers generally to a video or other electronic inspection of a surface under the control and supervision of an operator and/or inspector, for example, an inspection wherein a camera is mounted to a surface of interest and is under the control of a human operator.

However, a manual inspection of a surface may still be complicated to coordinate and conduct. An operator familiar with controlling the inspection system and familiar with the surface of interest may need to be present to control the camera. In addition, the operator may need to be skilled enough to ensure that the acquired video sequence of the surface provides coverage suitable for inspecting the surface and that the quality of the video is satisfactory for an inspector to properly view and make an accurate assessment of the condition of an inspection surface. Fulfilling such requirements is often time consuming and expensive to coordinate. Furthermore, a manual inspection sequence of a surface of interest may need to be carefully analyzed by an inspector who may or may not have recorded the inspection sequence him or herself.

Applicant has identified and appreciated that requiring an operator to manually acquire a video sequence each time a surface requires inspection may detrimentally affect the consistency of the resulting video sequence. Different or even the same operators are likely to produce inconsistent video sequences, with respect to not only the coverage of the inspection surface, but the quality of the video and the order in which an inspection sequence is captured. The term “inspection sequence” describes generally a sequence of image data obtained by an inspection system of a surface of interest. Accordingly, inspection sequences acquired from different manual inspections may not be correlated to one another, making comparison of two inspection sequences of the same surface difficult and time consuming even with expert involvement.

For example, a manual video inspection is often carried out by an operator and/or an inspector controlling a video camera mounted to a surface of interest. The video sequence may be transmitted directly to a display so that the operator may freely navigate around the surface of interest in search of suspect areas, cracks, material buildup, damage, corrosion, and/or any subject matter of interest present at the surface. The camera path by which the operator traverses the surface may be largely arbitrary and is likely to involve varying levels of backtracking and redundancy as well as a potential for less than full coverage of the inspection surface. In addition, camera parameters such as zoom and exposure time, and lighting levels of the inspection system may differ from operator to operator and inspection to inspection, producing non-uniform inspection sequences.

For surfaces that require regular inspections, it may not be possible to have the same operator and/or inspector controlling the acquisition of the inspection data of an inspection surface. Therefore, the camera path by which operators traverse the surface on any subsequent inspection is likely to be quite different. Furthermore, the inspection path that an operator, whether the same or different, traverses the surface on any subsequent inspection may deviate upon each subsequent inspection. Even when an operator intends to observe a prescribed path, two inspection sequences may be inconsistent.

Inconsistent inspection sequences make it difficult to correlate and compare information from successive inspections of a surface, for example, to track the progress or degradation of a surface over time and assess its condition. The ability to obtain such “trending” data may be useful in understanding a particular surface of interest. In addition, conventional cataloging and archiving of inspection data is complex and not always useful. For example, because manual control is vulnerable to inconsistency, each frame of an inspection sequence from one inspection will be of a view of a slightly different or entirely different portion of the inspection surface then in respective frames of any subsequent inspection sequence. Such inspection sequences are complicated to correlate in any meaningful way.

Applicant has identified and appreciated that manual inspection systems may benefit from various automation techniques that facilitate repeatable inspections of a particular surface of interest by utilizing a sequence of camera control parameters captured during an initial inspection under control of an operator (e.g., a manual inspection of a surface). This sequence of camera control parameters may then be reused to automatically control a video inspection system in any number of subsequent inspections to reproduce the same camera actions as produced under control of the operator. The resulting inspection data provides a consistent sequence of images of the surface each time the surface is inspected without requiring further operator involvement.

The term “automatic” applies generally to actions applied primarily by a computer, processor and/or control device. In particular, automatic tasks do not require extensive operator involvement and/or supervision. Accordingly, an “automatic inspection” refers generally to surface inspections carried out with little or no operator involvement, and more particularly, an automatic inspection describes acquiring inspection data of a surface of interest without an operator directly controlling the acquisition process. Inspection data refers to any information about the nature, condition, constitution and/or environment of a surface of interest and may include, but is not limited to, a sequence of images corresponding to different views of the inspection surface, camera control parameters associated with those views, environmental data acquired from various sensors of an inspection system, etc.

It should be appreciated that, in general, routine tasks such as connecting components of the inspection system for operation and tasks involved in the preparation and placement of an inspection system to begin acquiring inspection data of the surface of interest, referred to herein as “mounting” the system, are generally not considered operator control and will often be required even in automatic inspections.

Following below are more detailed descriptions of various concepts related to, and embodiments of, methods and apparatus according to the present invention for automating the inspection of surfaces of interest. It should be appreciated that various aspects of the invention, as discussed above and outlined further below, may be implemented in any of numerous ways, as the invention is not limited to any particular manner of implementation. Examples of specific implementation are provided for illustrative purposes only. In particular, while some embodiments of the invention discussed herein relate to inspection of tanks, it should be appreciated that automated inspection techniques according to other embodiments of the invention may be employed more generally with any type of surface of which inspection is desired.

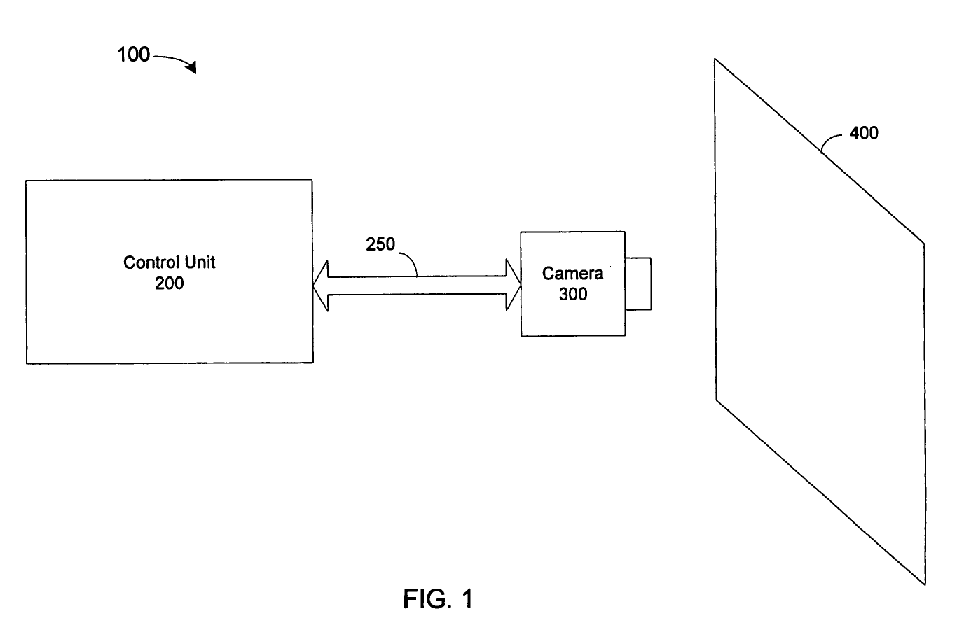

FIG. 1 illustrates one embodiment of an inspection system according to the present invention. Inspection system 100 includes a control unit 200, camera 300, and communications means 250. Control unit 200 may be any device or combination of devices having one or more processors capable of performing computational, arithmetic and/or logic operations and a memory capable of storing information received from communications means 250. Communications means 250 may be any suitable information link capable of bi-directional communication between control unit 200 and camera 300. For example, communications means 250 may be any information media and/or communications standard including, but not limited to, serial communications, parallel communications, category 5 (CAT5) cable, fire wire, etc. Communications means 250 may also be wireless communications, such as an infrared, radio, or any other suitable wireless link.

Camera 300 may be any image acquisition device capable of obtaining one or more images of an inspection surface 400. For example, camera 300 may be a video camera configured to acquire video of inspection surface 400 and provide the video to control unit 200 over communications means 250. In addition, camera 300 may be configured to receive camera control parameters from control unit 200 over communication means 250 to control the pose of the camera.

The term “camera control parameters” refers generally to one or more parameters describing a pose of a camera. The term “pose” will be used herein to describe a set of values wherein each value represents a camera's “location” along a dimension over which the camera is allowed to vary. For example, the pose of a camera may include both the position and the orientation of the camera in space (i.e., the external parameters describing the external pose of the camera) and settings such as zoom, focal length, lens distortion, field of view etc. (i.e., the internal parameters describing the internal pose of the camera).

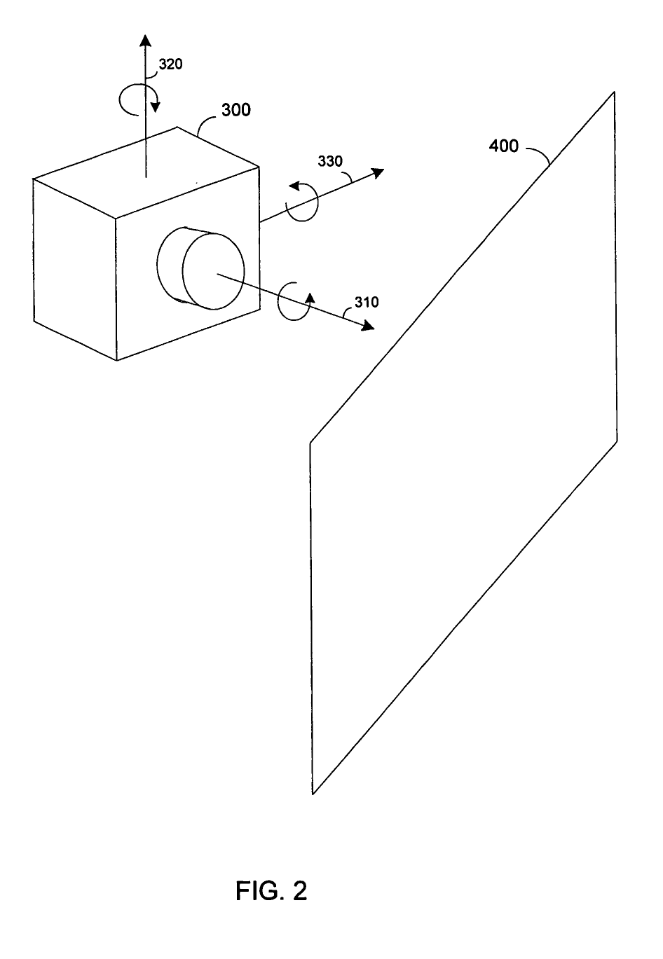

FIG. 2 illustrates a Cartesian coordinate frame that describes the orientation of camera 300 in space. The coordinate frame has three axes 310, 320 and 330. A unit vector along axis 310 is often referred to as the look-vector and the unit vector along axis 320 is often referred to as the up-vector. A unit vector along axis 330, typically the right-hand cross product of the look-vector and up-vector, is often referred to as the n-vector. Accordingly, the orientation of the camera may be described as the rotation of the look-vector, up-vector and n-vector about the axes 310, 320 and 330 of the camera coordinate frame, respectively.

A camera may be fixed along one or more of the axes. For example, a camera may be restricted such that the camera is not permitted to rotate about axis 320 but may rotate about axis 310 and 330. Stated differently, the up-vector of the camera may remain at a fixed value, for example, zero degrees rotation about axis 320 while the look-vector and n-vector are allowed to vary. Under such circumstances, the camera is considered to have at least two degrees of freedom. Varying the look-vector and the n-vector while holding the up-vector fixed is often referred to as a pan or a yaw action. Similarly, varying the look-vector and up-vector while holding the n-vector fixed is often referred to as a tilt or pitch action and varying the up-vector and n-vector while holding the look-vector fixed is often referred to as a roll action.

A camera may also be permitted to vary its position in space. For example, reference location 340 of camera 300 may be allowed to vary over one or more of axes 310, 320 and 330, for example, the X, Y and Z axes of a Cartesian coordinate frame. The three positional parameters and the three rotational parameters characterize the six dimensions of the camera coordinate frame and uniquely describe the external pose of the camera. It should be appreciated that coordinate systems such as cylindrical, spherical, etc. may alternatively be used to parameterize the space of a camera coordinate frame.

In addition, a camera may have parameters describing dimensions other than the six spatial dimensions described above. For instance, a camera may be allowed to vary across a range of zoom values. In addition, the focal distance, field of view, lens distortion parameters, etc. may be free to vary across a range of values or selected from a discrete set of values. Such parameters may describe the internal pose of the camera. The internal parameters may also include such variables as illumination, aperture, shutter speed, etc., when such parameters are applicable to a particular camera.

In general, a camera will be considered to have a degree of freedom for each dimension over which the camera is permitted to vary. However, the camera need not be capable of varying arbitrarily over a particular dimension to be considered free. For example, one or more dimensions may be limited to a range of values or restricted to a discrete set of values while still being considered a free dimension. A camera will typically have a camera control parameter for each degree of freedom.

When a camera is placed proximate an inspection surface, each unique set of camera control parameters describing a pose of the camera will produce an associated unique image of the inspection surface. Similarly, a sequence of camera control parameters, that is, a plurality of sets of camera control parameters, will produce a unique sequence of images of the inspection surface. As such, a substantially identical sequence of images may be obtained, for example, of inspection surface 400, each time inspection system 100 is mounted to inspection surface 400 and provided with the same sequence of camera control parameters.

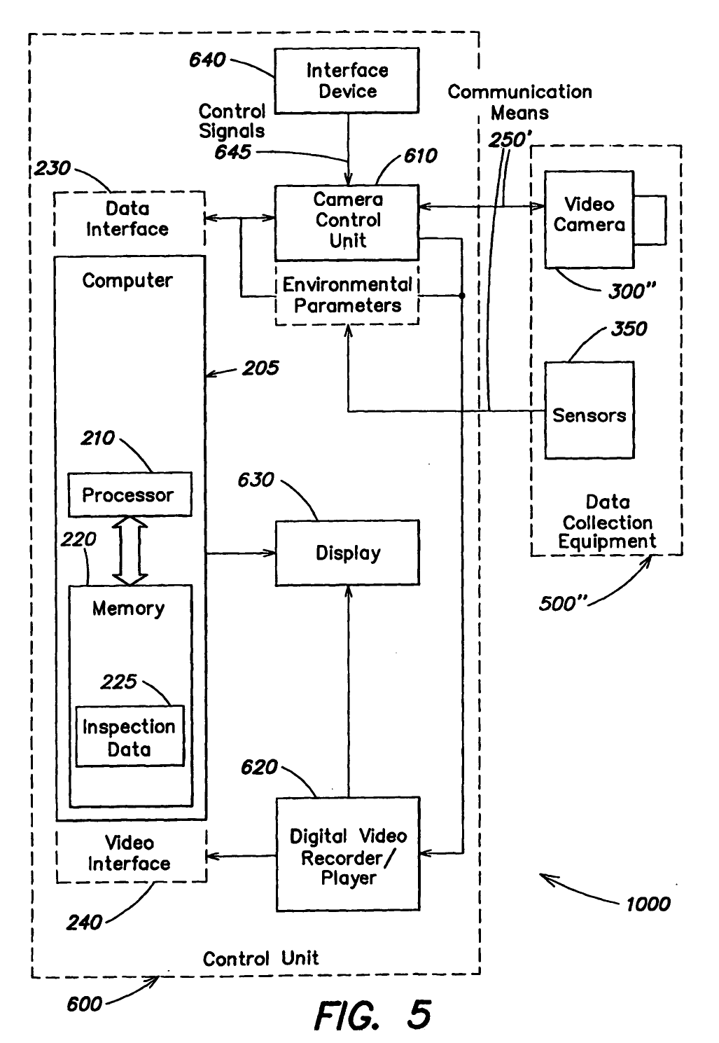

FIG. 3 illustrates one embodiment of an inspection system according to the present invention including an inspection system 100′ mounted to a tank 400′. Inspection system 100′ includes control unit 200 and data collection equipment 500. Data collection equipment 500 includes a video camera 300′ attached to a stalk 502, for example, an Insertable Stalk Imaging System (ISIS) manufactured by GeoCenters, Inc., Newton, Massachusetts. The ISIS data collection equipment is described in further detail in previously incorporated provisional application Ser. No. 60/367,221.

Data collection equipment 500 may be coupled to control unit 200 via communications means 250′. Data collection equipment 500 may include various means to secure video camera 300′ to stalk 502 such that the pose of the video camera can be varied with one or more degrees of freedom. For example, camera 300′ may be rotatably attached to stalk 502 such that the camera can pan and tilt across a desired range of values. In addition, the camera 300′ may be controlled such that the zoom of the camera can be adjusted such that the camera has at least four degrees of freedom.

When it is desired to inspect tank 400′, stalk 502 may be mounted to the tank at an entry point 402 such that video camera 300′ is stationed within the volume of the tank and in a position to acquire a sequence of images of the interior surface of the tank. Once the data collection equipment has been mounted, control unit 200 may begin issuing camera control parameters to the video camera via communications means 250′.

The data collection equipment may be mounted such that it has a known position relative to the inspection surface. For example, the mounting of inspection system 100′ may fix the position of video camera 300′. As such, camera control parameters issued to the video camera 300′ may have a constant value for the coordinate position of the camera. Alternately, since the position of the video camera in space may be implied by the mounting of the data collection equipment, the camera control parameters issued to the video camera may not need to include values for the position of the camera.

As such, camera control parameters including one or more rotational parameters and/or a zoom parameter may be sufficient to describe the pose of camera 300′. However, the number and type of camera control parameters in a set describing the pose of a camera will depend on the inspection system and the number of degrees of freedom with which the system is configured to operate.

The pose of camera 300′ may be adjusted according to each set of camera control parameters in the sequence issued from control unit 200 as it acquires video of the inside of the tank. Video camera 300′ may acquire one or more frames of video for each set of camera control parameters issued from control unit 200 and/or provide one or more frames of video as the camera transitions between poses. The resulting sequence of images is provided to control unit 200 via communications means 250′ and stored in a memory (not shown) that may be included in control unit 200 or otherwise disposed as discussed in further detail below.

Accordingly, each inspection of tank 400′ using the same sequence of camera control parameters will produce inspection sequences having substantially the same sequence of views of the tank. For example, the n^{th} image in two video inspection sequences acquired with the same sequence of camera control parameters will be a view of essentially the same region of the tank.

In this manner, inspection sequences may be obtained automatically to produce consistent information about the condition of the tank. Multiple inspection sequences of a surface of interest obtained periodically over an interval of time may be conveniently and accurately compared to detect regions of concern and to assess which regions may be degrading and at what rate. Moreover, an inspector need not be physically present for an inspection. Inspection sequences, once acquired, may be electronically transferred to wherever an inspector is located. Furthermore, inspection sequences obtained with an appropriate sequence of camera control parameters known to sufficiently cover the inspection surface will provide inspection sequences of the detail and quality such that the inspector can make a satisfactory inspection of the surface.

Data collection equipment 500 may collect other data in addition to image data. For example, data collection equipment 500 may include sensors that detect temperature, humidity, toxicity levels or any other environmental data that may be relevant to an inspection of a surface of interest. This environmental data may be transferred to control unit 200 via communications means 250′ separate from or in connection with the image data for an inspection.

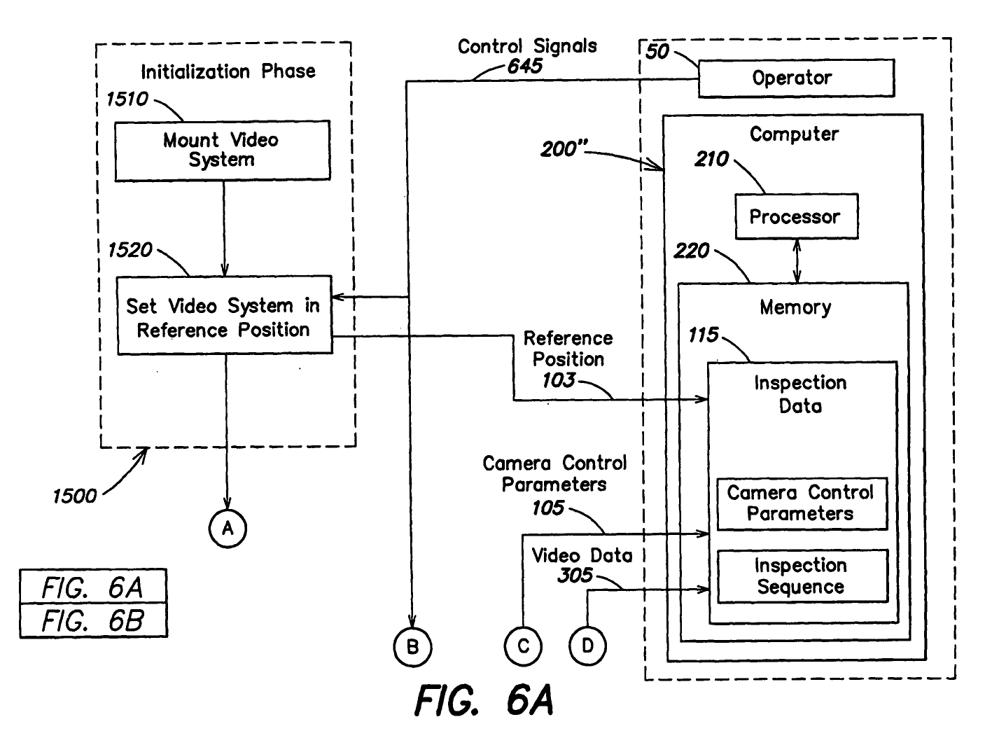

It should be appreciated that data collection equipment need not include a stalk or similar structure. Data collection equipment may include any structure or apparatus that facilitates the placement and/or positioning of the video camera proximate an inspection surface such that images of the surface may be acquired. For example, FIG. 4 illustrates one of numerous alternative structures for data collection equipment incorporating various aspects of the present invention.

In FIG. 4, data collection equipment 500′ includes a Remotely Operated Vehicle (ROV) having a video camera 300″ coupled to the front of the ROV and locomotion means 550 that facilitate navigation of the ROV through a fluid. One exemplary ROV is described in further detail in previously incorporated provisional application Ser. No. 60/367,221.

It should be appreciated that according to this embodiment, the camera is not fixed at any point in space. Hence, camera control parameters may include parameters indicating a desired position in space for the video camera. In addition, attaining a desired position in space may require a sequence of instructions applied to the locomotion means.

For example, a set of camera control parameters may include locomotion instructions including thrust magnitude, thrust angle, velocity and/or a time or duration of applying such parameters. A set of camera control parameters may include additional or fewer parameters in order to specify and control the video camera such that the it obtains images from a desired pose. Video camera 300″ may therefore have at least six degrees of freedom. It should be appreciated that in the embodiment of FIG. 4, the inspection of a tank 400′ may be carried out without having to detoxify or empty the tank of its contents.

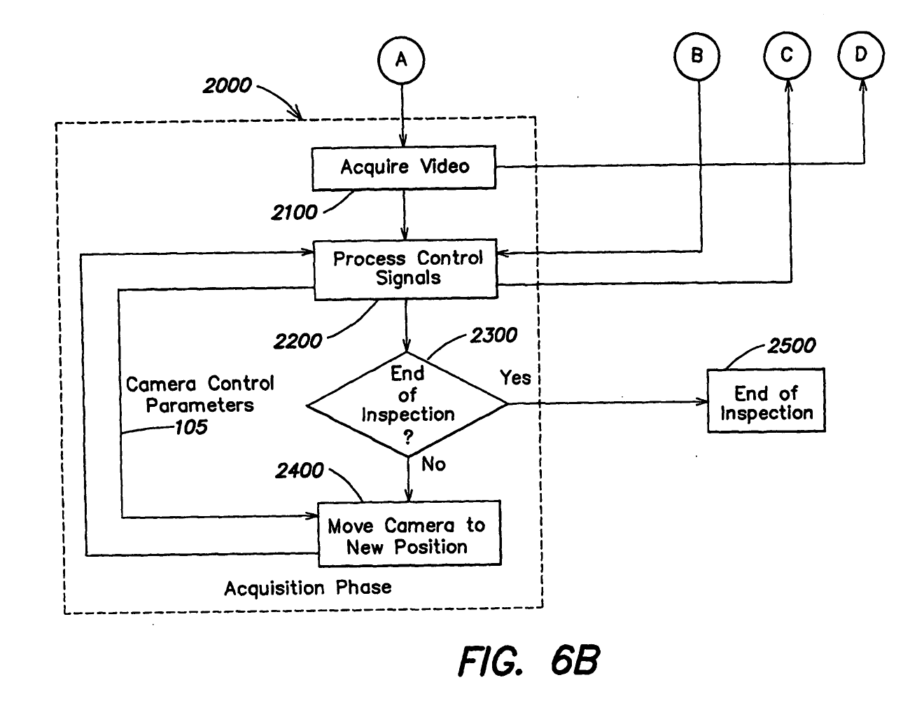

FIG. 5 illustrates another embodiment of an inspection system according to the present invention. Inspection system 1000 includes control unit 600 and data collection equipment 500″. Data collection equipment 500″ may include a video camera 300″ and sensors 350 that provide inspection data over communications means 250′. Control unit 600 may include a computer 205 having a processor 210, a memory 220, a data interface 230, and a video interface 240. The computer 205 may be coupled to a display 630 for viewing video of an inspection surface. Data interface 230 may be coupled to camera control unit 610 and the video interface 240 may be coupled to a digital video recorder 620.

Computer 205 may be any processor based device or combination of devices, for example, any of various general-purpose computers such as those based on Intel PENTIUM-type processor, Motorola PowerPC, Sun UltraSPARC, Hewlett-Packard PA-RISC processors, or any other type of processor. Many of the methods and acts described herein may be implemented using software (e.g., C, C#, C++, Java, or a combination thereof), hardware (e.g., one or more application-specific integrated circuits), firmware (e.g., electrically-programmed memory) or any combination thereof.

Camera control unit 610 may be any device or combination of devices capable of communicating bi-directionally with the data collection equipment to issue camera control parameters to the data collection equipment 500″ and receive inspection data from the data collection equipment. During an automatic inspection, camera control unit 610 may access camera control parameters stored in memory and issue the camera control parameters to the video camera.

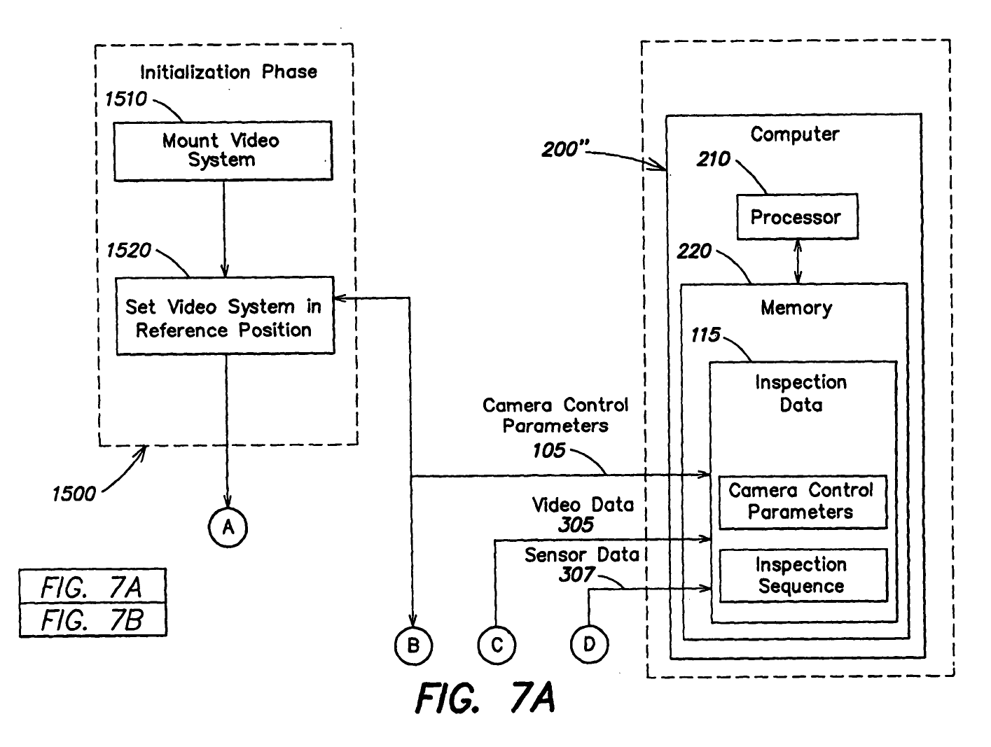

Camera control unit 610 may additionally be coupled to an interface device 640 and adapted to receive control signals 645. For example, in order to obtain a sequence of camera control parameters, it may be necessary to control the camera through an initial manual inspection of a surface of interest as discussed in further detail in connection with FIG. 6. During a manual inspection, camera control unit 610 may receive control signals 645 from interface device 640. The control signals may then be converted to camera control parameters by the camera control unit 610 and issued to the data collection equipment 500″.

Interface device 640 may be any device or combination of devices adapted to be manipulated by a user and configured to generate control signals indicative of the operator's actions. For example, interface device 640 may be ajoystick, trackball, control panel, touch-sensitive device or any combination of such devices capable of generating control signals in response to an operator indicative of desired camera movements for dimensions over which a camera is permitted or desired to vary.

The control signals 645 generated by interface device 640 are then interpreted by camera control unit 610 and converted into camera control parameters to be issued to the data collection equipment and, in particular, video camera 300″. The camera control parameters generated from operator control may also be issued to the computer for storage in memory 220 to facilitate a subsequent automatic inspection of the surface of interest as described in further detail below. In this manner, an operator can control the video camera as desired to obtain inspection data of an inspection surface and to generate camera control parameters corresponding to and capable of reproducing the inspection data.

The interface device 640 may alternately be coupled to computer 205 instead of camera control unit 610 and provide control signals 645 via, for example, serial interface 230. The computer 205 may be configured to convert the signals to camera control parameters or issue the control signals directly to camera control unit 610 to be converted into camera control parameters.

Digital video recorder/player 620 may be coupled to camera control unit 610 or alternatively, may be part of the camera control unit. The video recorder receives video information received from the video camera in order to format and arrange the information into any of various desirable video formats. Digital video recorder may, for example, format the video information such that it can be transmitted to video interface 240 and stored in the memory of computer 205 as inspection data 225.

In addition to the video information, the digital video recorder/player may receive camera control parameters, sensor data, environmental parameters and/or any other information from data collection equipment 500″. The digital video recorder/player may then, if desired, overlay some or all of the camera control parameters and environmental parameters onto the video data. The video data with or without the overlay may be transmitted to display 630 for viewing. An operator may view the display, for example, during a manual inspection to ensure that the camera control parameters obtained correspond to a satisfactory inspection sequence of the inspection surface providing adequate coverage and quality.

It should be appreciated that control unit 600 may be located proximate to the inspection surface or located physically remote from the inspection surface. In one embodiment, the control unit is a mobile device. Numerous variations to the components and arrangement of control unit 600 will occur to those skilled in the art. However, any apparatus capable of issuing camera control parameters associated with an inspection sequence and obtaining inspection data according to the camera control parameters is considered to be within the scope of the invention.

As discussed above, it may be desirable to have an operator control a camera through an initial manual inspection of a surface of interest and store the camera control parameters resulting from the manual inspection in memory. The stored camera control parameters can later be automatically issued to the camera, obviating the need to have a trained and/or expert operator present during subsequent inspections. Moreover, the inspection data obtained from the stored camera control parameters eliminates problems associated with operator error and inconsistency.

However, a sequence of camera control parameters need not be obtained through manual control of the data collection equipment. For example, an operator and/or programmer may program a sequence of camera control parameters that when applied to an inspection apparatus results in an inspection sequence of a surface of interest based on known surface geometry of a particular surface or class of surfaces of interest.

For example, the general geometry of a surface or class of surfaces may be known such that a programmer may program a sequence of camera control parameters directly and store them, for example, on a storage medium such as a computer memory without requiring the camera control parameters to be obtained through manual control of the data collection equipment. Subsequent inspections of such a surface or surface or substantially similar surface may be automated by applying the sequence of camera control parameters to an inspection apparatus mounted to the surface.

FIGS. 6A and 6B illustrate one embodiment of a method of generating a sequence of camera control parameters by recording the movements of an operator during a manual inspection of a surface of interest. In an initialization phase 1500, an inspection system is arranged in preparation for inspecting the surface. In step 1510, the inspection system is mounted to the inspection surface such that images of the surface may be obtained. In step 1520, the camera is moved to a desired reference pose. The reference pose typically refers to the pose of the camera at the beginning of each inspection. The reference pose may be, for example, the first set of camera control parameters stored in a sequence of camera control parameters.

After the inspection system has been mounted and the camera placed in its reference pose, acquisition of a sequence of camera control parameters may begin. In acquisition phase 2000, a sequence of camera control parameters corresponding to the actions of operator 50 are recorded and stored in inspection data 115 in memory 220 of computer 200″. In step 2100, the camera begins acquiring video of the inspection surface from its current pose. The image data is transmitted to camera control unit 600′ where it is stored as inspection data 115 and may be displayed to the operator to aid the operator in correctly controlling the camera.

In step 2200, control signals resulting from the operator's actions, for example, control signals output by an interface device, are received and processed to provide camera control parameters 105 to the camera. The control signals may be any of various signals proportional to variation of the interface device along one or more dimensions as caused by the operator. The control signals 645 may need to be converted to camera control parameters in a format understood by the camera. In addition, the control signals may include further information such as indications to pause, resume or otherwise indicate that the inspection has been completed and the camera should stop recording. The camera control parameters 105 resulting from the control signals may then be stored as inspection data 115.

In step 2400, camera control parameters 105 generated in step 2200 are used to move the camera to a new position described by the camera control parameters. This process is repeated until the operator stops generating control signals, stops recording or otherwise indicates that the inspection has been completed as shown in step 2300. It should be appreciated that in the acquisition phase, the camera may continually be acquiring images at video rate, for example 60 frames per second, as the camera receives camera control parameters to adjust its pose as shown in the loop including steps 2200, 2300 and 2400. As such, when the inspection ends in step 2500, a sequence of camera control parameters may be generated along with the associated video which may be stored as inspection data 115.

In another embodiment, an operator may record an inspection without the data collection equipment and/or the surface of interest. In some cases, the geometry of a surface of interest to be inspected may be known. In such cases, a trained operator may program a sequence of camera control parameters that, when applied to an inspection system mounted to the surface of interest, will provide inspection data having coverage sufficient to perform an inspection of the surface of interest.

Additionally, the camera control parameters resulting from a manual inspection may be combined and/or modified with programmed camera control parameters. It may be desirable for an operator to adjust the sequence of camera control parameters resulting from operating the video camera directly in order to provide a sequence of camera control parameters that will provide additional image inspection data of particular portions of the surface of interest and/or remove certain camera control parameters that result in unnecessary, redundant, or otherwise undesirable images of the inspection surface. For instance, an operator may want to add zoom sequences to a sequence of camera control parameters in order to provide close-ups of particular portions or regions of the surface of interest and/or may want to otherwise edit the sequence of camera control parameters.

A sequence of camera control parameters may be obtained by recording a sequence of camera movements or actions by either capturing in real time the camera control parameters resulting from a manual control of a video inspection system, by directly programming a sequence of camera control parameters corresponding to a known sequence of camera movements for a particular surface of interest or a combination of both. In addition, once a sequence of camera control parameters have been obtained by methods described above, they may be sent electronically to remote locations and stored in any number of other inspection systems, storage medium, network devices, etc.

A sequence of camera control parameters obtained as described in the foregoing may be employed to facilitate an automatic inspection of a surface of interest. A subsequent inspection of the same or similar surface of interest may be acquired by reading the camera control parameters from the memory of the control unit or from some other source accessible by the automated inspection system and applying the camera control parameters to the video camera, thus automatically reproducing the movements performed by the operator without requiring the operator to be present.

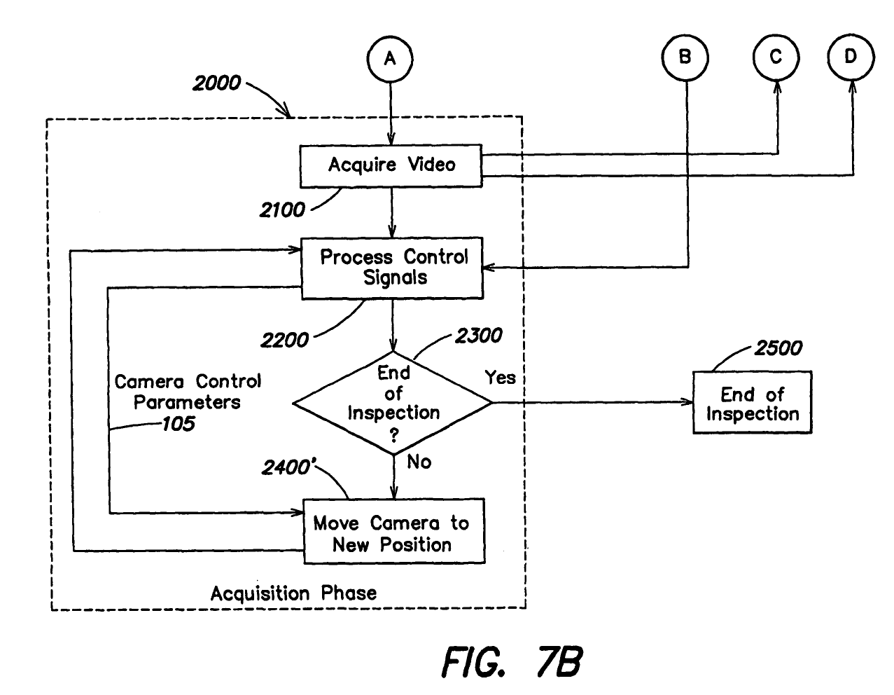

FIGS. 7A and 7B illustrate one embodiment of a method of automatically obtaining inspection data of a surface of interest according to the present invention. The method includes steps substantially the same as the method illustrated in connection with the manual inspection of FIGS. 6A and 6B. However, an operator may not be required in order to obtain inspection data. In step 2400′, camera control parameters are received from memory, for example, from inspection data 115 stored in computer 200″ from a previous manual inspection and/or programming. Since the camera control parameters are the same as those issued in response to control by the operator, the video data 305 will include a sequence of images having substantially identical views in the same order as they were acquired during the manual inspection. In this way, consistent inspection data can be acquired of a surface of interest by employing the stored sequence of camera control parameters at any time, in any location, and without requiring a skilled operator to be present.

It should be appreciated that even with automatic acquisition of an inspection data as described in the foregoing, a trained and often certified or licensed inspector must carefully analyze the inspection data in order to make an assessment of the surface of interest. This process may include a human inspector examining the video acquired of a surface of interest to evaluate the level of corrosion, detect anomalies in the surface, discover any breaches of the integrity of the inspection surface, etc. In addition, an inspector may compare the inspection sequence with an inspection sequence of the surface of interest acquired previously to assess if the surface may have substantially changed since the last inspection, for example, to determine where and how fast suspect regions of the surface of interest are deteriorating.

However, requiring that a trained inspector manually analyze inspection data is expensive, time consuming, and vulnerable to inspector subjectivity. Accordingly, Applicant has identified and developed automatic methods of analyzing a sequence of images to inspect them to determine the condition of the surface, assess damage to the surface, or detect any subject matter of interest that a human inspector may look for in a physical or manual inspection of a surface of interest. Such automatic processing of inspection data may provide a less subjective, more convenient, reproducible, and cost effective method of inspecting a surface of interest.

Automatic processing of inspection data applies generally to inspection and/or assessment of inspection data with little or no inspector involvement. More specifically, it describes any of various algorithms adapted to accomplish substantially similar inspection tasks conventionally carried out by a human inspector. In combination with various automatic acquisition methods and apparatus described in the foregoing, automated techniques for analyzing the inspection sequence may obviate regular operator and/or inspector assistance required in conventional inspection systems.

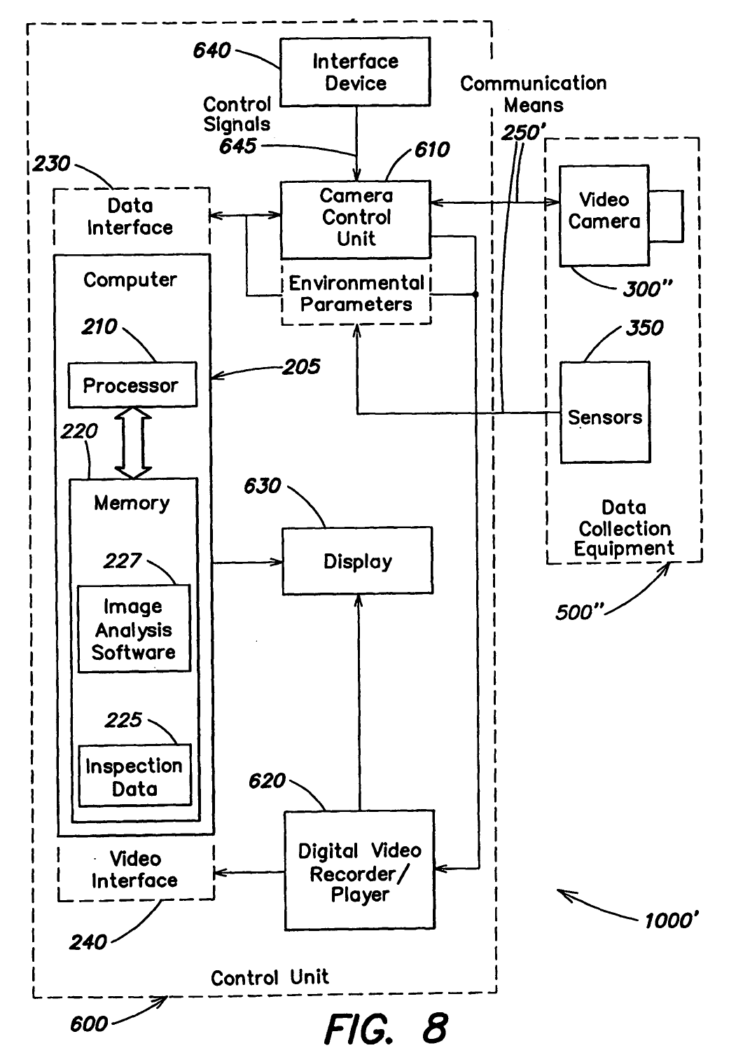

FIG. 8 illustrates one embodiment of an inspection system including automatic analysis software according to the present invention. Inspection system 1000′ may include similar components as inspection system 1000′ described in connection with FIG. 5. However, inspection system 1000 may include automatic image analysis software 227 that may be stored in memory 220 of the computer 205 and executable by processor 210.

For example, memory 220 may be any of various computer-readable medium, for example, a non-volatile recording medium, an integrated circuit memory element, or a combination thereof. The memory may be encoded with instructions, for example, as part of one or more programs, that, as a result of being executed by processor 210, instruct the computer to perform one or more of the methods or acts described herein, and/or various embodiments, variations and combinations thereof. Such instructions may be written in any of a plurality of programming languages, for example, Java, Visual Basic, C, C#, or C++, Fortran, Pascal, Eiffel, Basic, COBAL, etc., or any of a variety of combinations thereof

The computer-readable medium on which such instructions are stored may reside on one or more of the components of control unit 600 or may be distributed across one or more of such components and or reside on one or more computers accessible over a network.

Accordingly, when the image analysis software is executed by processor 210 an inspection sequence received from data collection equipment 500″ may be automatically analyzed to assess the condition of the inspection surface.

It should be appreciated that the breadth of surfaces that may be inspected according to automatic acquisition techniques described in the foregoing is far reaching and may include surfaces exposed to varied environments, of a wide range of textures and having different inspection requirements. Accordingly, the nature of the detection algorithm may depend on the subject matter of interest, the presence or absence of which the algorithms are designed to detect. However, any method, program or algorithm configured to automatically detect and evaluate the presence or absence of subject matter of interest present in one or more images of an inspection surface is considered to be within the scope of the invention.

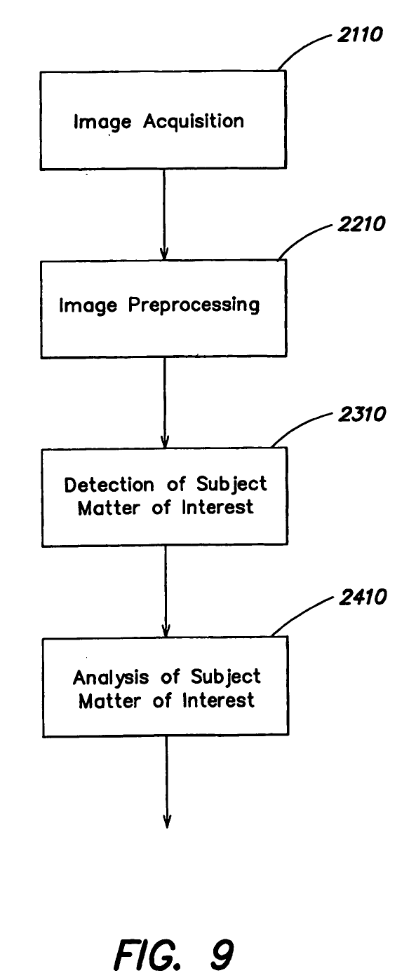

FIG. 9 illustrates one method according to the present invention of analyzing a sequence of images of an inspection surface in order to identify and evaluate subject matter of interest present in the images. For example, the sequence of images may have been acquired according to the various methods of automatically obtaining inspection data of a surface as described in the foregoing.

In step 2110, an image to be analyzed is obtained, for example, from an inspection sequence stored in memory or directly streamed from real-time video acquisition during an inspection of a surface of interest. The image may then be preprocessed in step 2210 to prepare the image for subsequent analysis. Any of various image preprocessing methods such as noise removal, image smoothing, image orientation, scaling, change of color depth, etc., may be employed to prepare the image as desired for analysis. In some embodiments, an image may not require image preprocessing. For example, images obtained from memory may have already been preprocessed or the various analysis techniques employed may not require preprocessing.

In step 2310, the image content is analyzed in order to detect the presence or absence of subject matter of interest. As noted above, the subject matter of interest may vary from inspection surface to inspection surface. For example, a surface may be inspected for the presence of cracks or other breaks in the integrity of the surface such as in a container holding nuclear waste or other hazardous material, a pipeline may be inspected for build-up of material that may impede the conveyance of fluid through the pipeline, a tank may be inspected for corrosion on the surface, etc. Each type of subject matter to be detected may have characteristics that require different recognition techniques in order to detect the presence of the subject matter of interest. For example, various edge analysis techniques, color analysis, shape and/or template matching, texture analysis, etc., may be employed to detect the subject matter of interest. The various techniques available may be optimized to adequately distinguish the particular subject matter of interest from the rest of the image content.

Once the presence of the subject matter of interest has been detected, its substance may be evaluated in step 2410. For example, the nature and extent of the present subject matter may be ascertained by employing various methods that may assess the quantity of the subject matter of interest, its quality, severity or any other measurement that may facilitate assessing the condition of the surface of interest. The assessment may provide inspection results for the particular image. This process may be repeated for each of the images in an inspection sequence such that a complete inspection and assessment of a surface of interest may be conducted automatically.

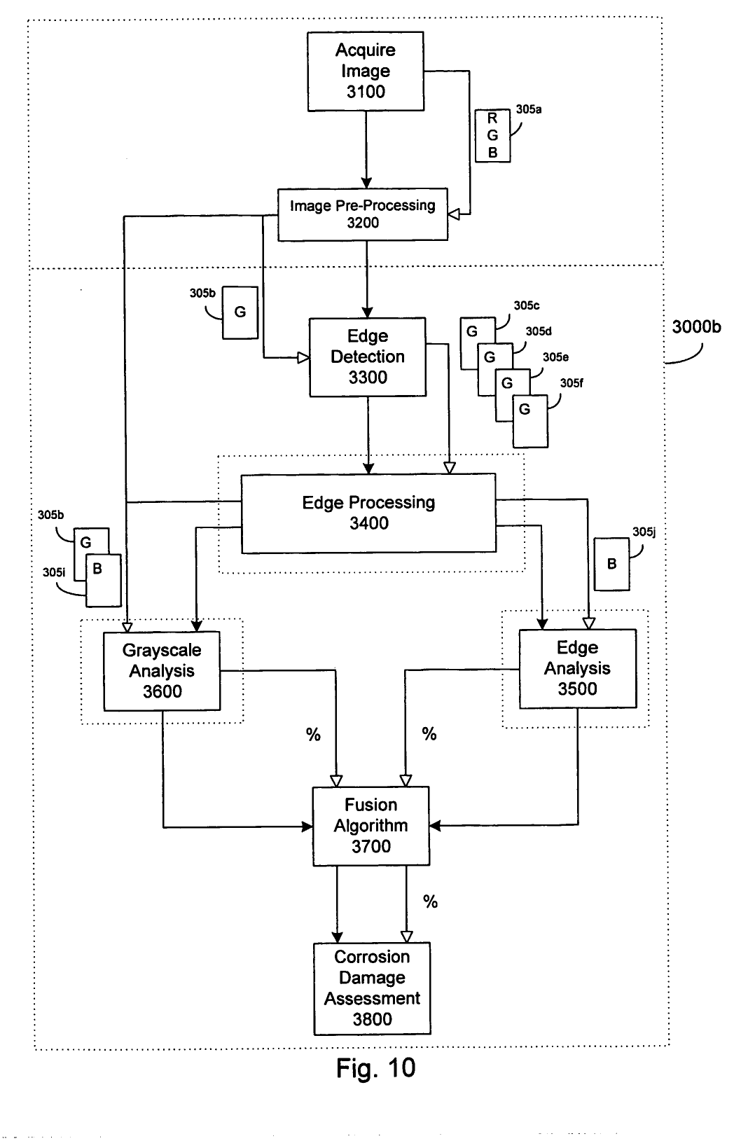

FIGS. 10-13 illustrate one embodiment of a method of automatically analyzing an inspection sequence according to the present invention. The method is illustrated in connection with inspection of a ship board ballast tank to determine the level of corrosion present on the inside surface of the tank. However, the underlying concepts may be customized to automatically detect the particular features of any of a variety of surfaces.

The ballast tanks of ocean going vessels are often filled with salt water for long periods of time and are vulnerable to rust and corrosion that, at certain levels, may warrant a tank to be treated with a protective coating or at more severe levels may affect the integrity of the tank. Ocean going vessels are often employed to carry cargo from port to port and therefore the location of the ship will depend largely on its shipping schedule. As such, a certified inspector may not be available at the location of a ship when an inspection of the tank is required such that expensive and inconvenient scheduling of inspections may be required. In addition, subsequent inspections of the tanks would likely have to be performed at a different locale by a different inspector, making regular inspections vulnerable to inspector subjectivity and inconsistency.

FIG. 10 illustrates one method of automatically calculating the percentage of a region of a surface of interest containing subject matter of interest, for example, corrosion on the inside of a ballast tank. An inspection sequence of the tank may be analyzed on an image by image basis. In step 3100, an image from an inspection sequence is acquired. For example, in the automatic acquisition method described in connection with FIG. 7, as the camera provides video information to the control unit, the individual frames of the video may be input to the automatic analysis software to detect and assess the amount of subject matter of interest present in the image.

In step 3200, a color image 305a is preprocessed to prepare the image for processing. Preprocessing may include converting the image to a format preferable for processing, for instance, converting the image from color to grayscale. In addition, it may be desirable to smooth the image in order to remove any noise inherited from the image acquisition device or otherwise. In the embodiment of FIG. 10, the color image is converted to a grayscale image 305b and noise is removed from the image by performing a two dimensional discrete wavelet transform using the Haar wavelet, applying thresholds to the directional detail coefficients, and then performing the inverse discrete wavelet transform.

The noise removal technique used in any implementation may depend on the type of noise present in the images collected from a particular inspection system. Gaussian smoothing, median filtering or other methods of removing noise and high frequency content may be employed during preprocessing in the place of or in combination with a wavelet transformation.

After the image has been preprocessed, the image is introduced to a feature detection phase 3000b. It should be appreciated that the type of feature detection techniques employed may depend on the characteristics of the subject matter of interest intended to be automatically detected. Feature detection may include any of various region segmentation algorithms, color or grayscale analysis, shape analysis, template matching, edge analysis or any combination of the above that the developer deems appropriate for detecting the subject matter of interest in an image.

Applicant has identified and appreciated that corrosion in an image exhibits characteristic edge patterns that may be distinguished from other image content by various edge analysis algorithms. In step 3300, edge detection is performed on grayscale image 305b. Numerous edge detection techniques are available for quantifying edge information based on gradient peaks, second derivative zero-crossings, frequency spectrums, etc. Such edge detection algorithms include Sobel, Canny-Diriche, Marr-Hildreth, SUSAN, and numerous others, any of which may be applicable to extracting edge information from images of an inspection sequence.

In the embodiment illustrated in FIG. 10, edge detection is accomplished using a wavelet decomposition of the image. A single level decomposition of the image using the discrete wavelet transform and the SYM2 wavelet is performed, resulting in four decomposed images 305c-f. The decomposed images include an approximation image 305c containing the lower spatial frequency information and three detail images 305d-f that include the higher spatial frequency image information in the horizontal, vertical and diagonal directions, respectively.

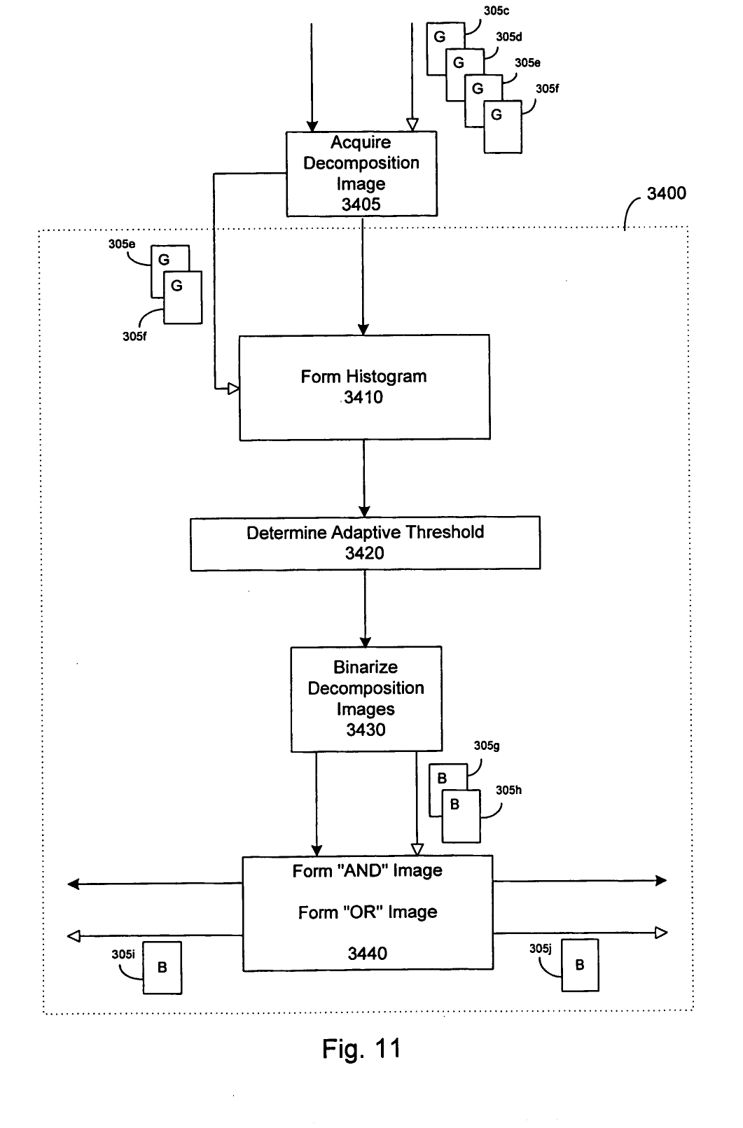

In step 3400, the edge information is analyzed to remove weak edge information. One method of edge processing 3400 illustrated in FIG. 10 is described in detail in connection with FIG. 11. In FIG. 11, the images 305e and 305f representing the horizontal and vertical edge information are analyzed statistically. In step 3410, a histogram of the horizontal and vertical detail images is generated. The histogram is modeled as a Gaussian distribution and the mean and standard deviation of the distribution are computed using a least squares method. The mean and standard deviations are then employed to generate image specific thresholds to remove weak edge information, specifically, by binarizing the edge images based on the computed thresholds.

Variations in lighting, focus and other properties that may occur due to the use of different equipment often result in images having variation in the dynamic range of the intensity values in the image. Consequently, using a fixed threshold to generate the binary edge images may not be appropriate. Therefore, the statistics of each image are used in order to develop an adaptive threshold. In one embodiment, the distribution of edge information is shifted such that the mean takes on a value of zero. The mean shifted histogram, in part, normalizes the images such that an image dependent threshold may be computed based on the deviation from the Gaussian model to provide edges that are consistent across images from different sequences or images in the same sequence taken of various regions of the surface of interest.

In step 3420, an adaptive threshold may computed by setting the threshold value a desired number of standard deviations from the mean. For example, only edge information having levels greater than the mean plus two standard deviations and the levels less than the mean minus two standard deviations are considered as true edges.

In step 3430, the adaptive thresholds determined in step 3420 may be used to binarize the horizontal and vertical images 305e and 305f containing edge information to arrive at images indicative of the presumed true horizontal and vertical edges in the image. Having generated vertical and horizontal edge images 305g and 305h, a pair of composite edge images are generated in step 3440.

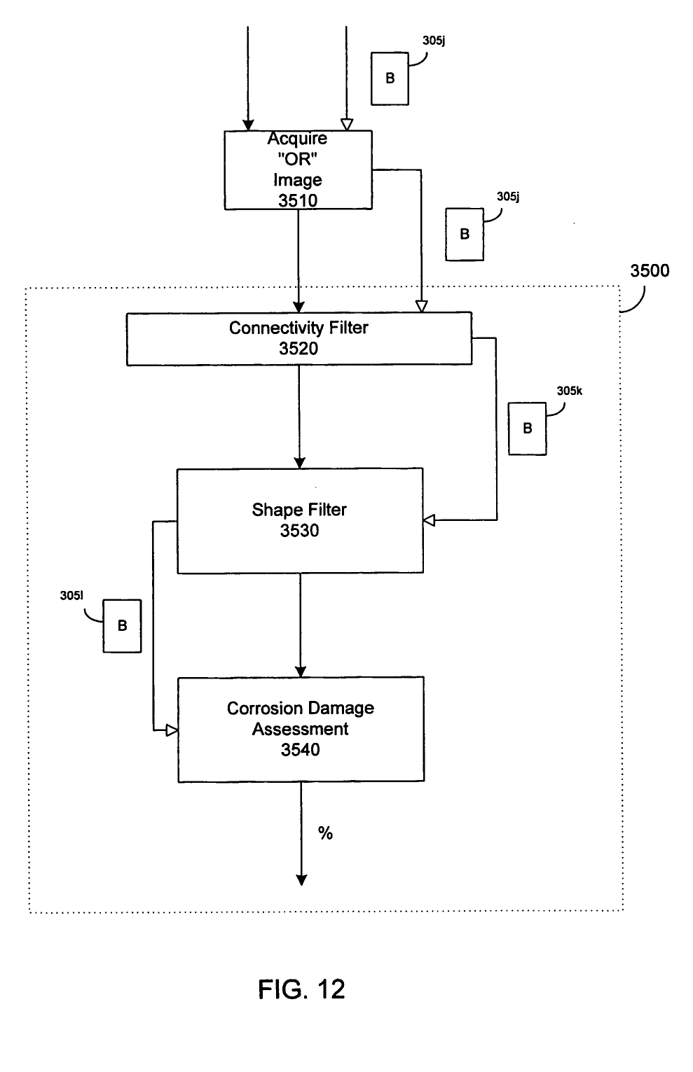

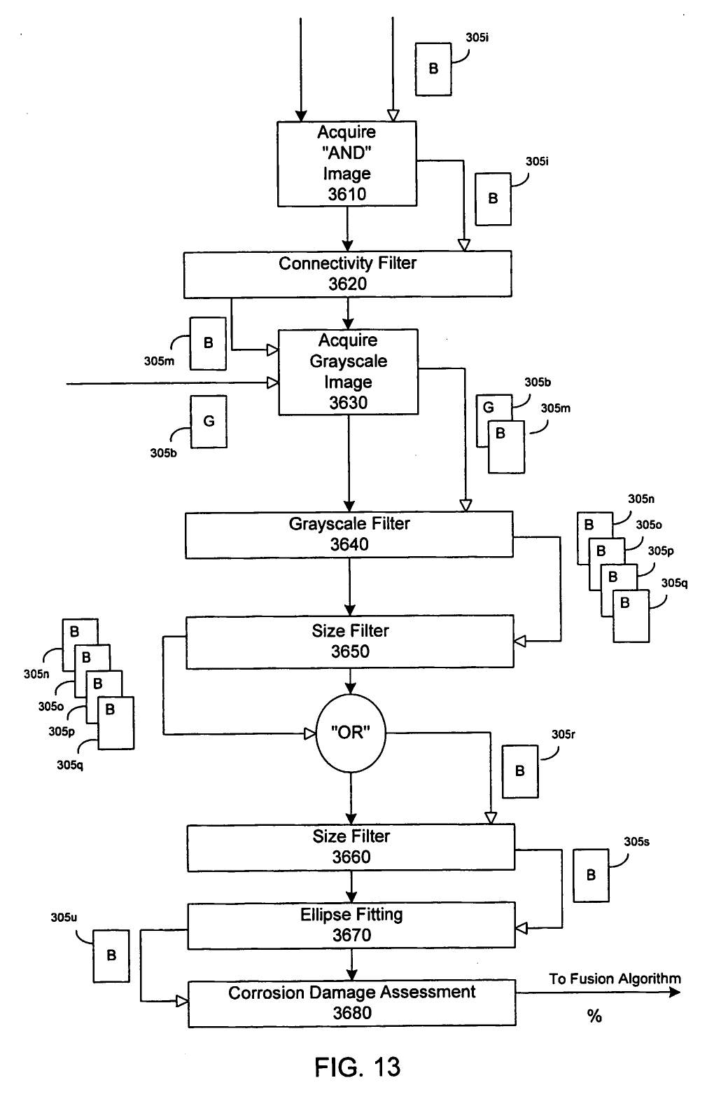

The first composite image 305i is an “AND” image formed by performing the logical AND operation on each of the corresponding binary pixels of the vertical and horizontal edge images 305g and 305h. The second composite image is an “OR” image 305j, formed by performing a logical OR on each corresponding binary pixel of the horizontal and vertical images 305g and 305h. The “OR” image 305j is provided to edge analysis 3500 shown in FIG. 10 and described in further detail in FIG. 12. The “AND” image 305i is provided to greyscale analysis 3600 shown in FIG. 10 and described in greater detail in FIG. 13.

The “OR” image is provided to edge analysis 3500 shown in FIG. 10 which is described in further detail in connection with FIG. 12. In step 3510, the “OR” image 305j is received from edge processing step 3400. In step 3520, the OR image may be filtered according to connectivity by labeling pixels using a four-point connectivity morphology. This operation results in edge clusters that are linked together by pixels in a four neighborhood.

The clusters are then filtered by size and all clusters that do not fall within a predetermined range are removed. For instance, all clusters having less than 5 pixels or greater than 300 pixels are removed from the image to produce binary image 305k. The term removed refers to toggling the binary value of a pixel when a filter criteria is not met. For example, if a value of 0 represents an edge pixel and the criteria of a particular filter is not met, the value of the pixel is changed to 1. Likewise, if a value of 1 represents an edge pixel and the criteria of a particular filter is not met, the value of the pixel is changed to 0.

In step 3530, image 305k is filtered based on the shape of the remaining edge clusters. For example, the remaining clusters may be fit with ellipsis. The eccentricity of each ellipse may then be calculated to ascertain the general shape of an edges cluster. Clusters fit with an ellipse having eccentricities greater than a threshold value, for instance, 0.95 are removed to provide binary image 305l. Filtering out shapes having high eccentricity values (e.g., greater than 0.95) may remove clusters that are line-like in appearance that often result from straight edges associated with objects such as pipe structures and baffle holes present in tanks being inspected.

The remaining clusters present in image 3051 are considered to represent edges resulting from corrosion on the inside of the tank being inspected. In step 3540, a damage value is computed by dividing the number of remaining edge pixels by the total number of pixels in the image. This damage value is then provided to a fusion step 3700 shown in FIG. 10.

The “AND” image 305i generated during edge processing step 3400 along with the grayscale image 305b generated in image pre-processing step 3200 are provided to a grayscale analysis 3600 shown in FIG. 10 and described in further detail in FIG. 13.

In step 3620 of FIG. 13, the “AND” image 305i is provided to a connectivity filter that uses a four-point connectivity morphology to cluster edge pixels in the manner described above in connection with step 3520 of edge analysis 3500. Clusters having less than a threshold value, for example four pixels, are removed to form binary image 305m.

In step 3630, the remaining clusters in image 305m are compared with the gray levels of the corresponding pixels in grayscale image 305b which is the original greyscale representation of the image being processes. The grayscale information is then used in conjunction with the cluster information in step 3640 to further isolate areas that are presumed to have resulted from corrosion.

For example, statistics may be calculated on the grayscale values in image 305b on a cluster basis. The median and standard deviation of the grayscale values of each cluster remaining in image 305m and the median and standard deviation of the grayscale values of all remaining clusters may be calculated. Clusters having a median grayscale value less than or equal to the median of all remaining clusters plus or minus a tolerance standard deviation are kept and all other clusters are removed to provide binary images 305n-305q.

In step 3650, each of images 305n-305q are filtered by size, for example, by removing clusters have more than 600 pixels. The images are then logically OR'ed together to produce a single clustered edge image 305r. This image may then be again filtered based on cluster size in step 3660, for example, by removing all clusters having less than 5 pixels to provide image 305s.

In step 3670, the remaining clusters in image 305s are then fit with an ellipse and filtered based on characteristics of the major and minor axis of the resulting ellipse fit. Each cluster having an associated ellipse with a major axis greater than a first threshold or a minor axis less than a second threshold are removed. Exemplary values for the first and second threshold are 10 pixels and 5 pixels, respectively.

The remaining clusters in the resulting image 305u are considered to represent edge pixels resulting from corrosion on the inside of the tank being inspected. A damage value is calculated by dividing the number of remaining edge pixels by the total number of pixels in the image. This assessment value is then provided to the fusion step 3700 illustrated in FIG. 10.

In step 3700, the damage value computed during edge analysis 3500 and the damage value calculated in the grayscale analysis 3600 are fused to arrive at a damage assessment value for the image being processed. In one embodiment, the damage values computed in edge and grayscale analysis are averaged to produce the total damage assessment value indicating the inspection result for the particular image being processed.

The method described in the foregoing may then be repeated on each image in an inspection sequence. The total damage assessment values for each image may be summed in order to arrive at a total damage assessment value for the surface of interest, in particular, the ballast tank to provide an inspection result for the surface of interest. In this way, the corrosion level of a ballast tank can be automatically determined without requiring the presence of a licensed or certified inspector to examine an acquired video sequence.

Having described several embodiments of the invention in detail, various modifications and improvements will readily occur to those skilled in the art. Such modifications and improvements are intended to be within the scope of the invention. Accordingly, the foregoing description is by way of example only, and is not intended as limiting. While some examples presented herein involve specific combinations of functions or structural elements, it should be understood that those functions and elements may be combined in other ways according to the present invention to accomplish the same or different objectives. In particular, acts, elements and features discussed in connection with one embodiment are not intended to be excluded from a similar role in other embodiments. The invention is limited only as defined by the following claims and the equivalents thereto.

1. A method of repeating an inspection of a surface of interest with an inspection system including a control unit coupled to a camera, the method comprising acts of:
providing a sequence of camera control parameters corresponding to first inspection data of the surface of interest from the control unit to the camera; and
acquiring at least one second inspection data of the surface of interest according to the sequence of camera control parameters.

2. The method of claim 1, wherein the act of providing the sequence of camera control parameters includes an act of providing a sequence of camera control parameters having resulted at least in part from manually acquiring a first sequence of images of the surface of interest.

3. The method of claim 1, wherein the act of providing the sequence of camera control parameters includes an act of providing a sequence of camera control parameters having resulted at least in part from operator programming.

4. The method of claim 1, wherein the act of acquiring at least one second inspection data of the surface includes an act of acquiring an inspection sequence of images of the surface of interest.

5. The method of claim 4, wherein the sequence of camera control parameters includes a plurality of sets of camera control parameters, each set of camera control parameters defining at least one pose of the camera.

6. The method of claim 5, wherein the act of acquiring an inspection sequence of images includes an act of acquiring at least one image from each pose of the camera defined by the plurality of sets of camera control parameters.

7. The method of claim 6, wherein each set of camera control parameters includes a value related to at least one of a pan action, a tilt action, a zoom and a position.

8. The method of claim 5, further comprising an act of mounting the camera at a reference location having a known position relative to the surface of interest.

9. The method of claim 8, wherein the act of applying the sequence of camera control parameters includes an act of applying the sequence of camera control parameters such that each set of camera control parameters is an offset from the reference location.

10. The method of claim 8, wherein the act of applying the sequence of camera control parameters includes an act of applying the sequence of camera control parameters such that each set of camera control parameters is an offset from an immediately preceding pose of the camera.

11. The method of claim 1, further comprising an act of obtaining the sequence of camera control parameters from a computer readable medium.

12. An inspection apparatus adapted to automatically acquire inspection data of a surface of interest, the apparatus comprising:
data collection equipment including a camera capable of acquiring at least one image of the surface of interest; and
a control unit coupled to the data collection equipment, the control unit configured to provide a sequence of camera control parameters corresponding to first inspection data of the surface of interest to the camera to acquire at least one second inspection data of the surface of interest.

13. The method of claim 12, wherein the sequence of camera control parameters result at least in part from acquiring a first sequence of images of the surface of interest.

14. The method of claim 12, wherein the sequence of camera control parameters result at least in part from operator programming.

15. The method of claim 12, wherein the at least one second inspection data includes an inspection sequence of images of the surface of interest.

16. The apparatus of claim 15, wherein the sequence of camera control parameters includes a plurality of sets of camera control parameters, each set of camera control parameters defining a pose of the camera such that the inspection sequence of images includes at least one image acquired from each pose defined by the plurality of sets of camera control parameters.

17. The apparatus of claim 16, wherein each set of camera control parameters includes a value for at least one of a pan action, a tilt action, a zoom action, and a position.

18. The inspection apparatus of claim 12, wherein the camera is a video camera.

19. The inspection apparatus of claim 18, wherein the video camera has at least two degrees of freedom.

20. The inspection apparatus of claim 18, wherein the video camera has at least four degrees of freedom.

21. The inspection apparatus of claim 18, wherein the video camera has at least six degrees of freedom.

22. The inspection apparatus of claim 15, wherein the control unit comprises a computer having a memory for storing at least one sequence of camera control parameters.

23. The inspection apparatus of claim 22, wherein the memory is encoded with at least one program configured to automatically analyze the inspection sequence of images to detect the presence or absence of subject matter of interest in each image in the sequence.

24. The inspection apparatus of claim 23, wherein the at least one program automatically analyzes the inspection sequence of images by distinguishing subject matter of interest from the image content by at least one of color analysis, edge analysis and shape analysis.

25. The inspection apparatus of claim 24, wherein the at least one program provides an inspection result of the surface of interest.

26. The inspection apparatus of claim 22, further comprising a video recorder coupled to the video camera and the computer, the video recorder adapted to receive video data from the video camera and to provide image information based on the video data to the computer.

27. The inspection apparatus of claim 26, wherein when the inspection system is operating on the sequence of camera control parameters the video data includes an inspection sequence of images of the surface of interest and the image information includes a digital inspection sequence of images of the surface of interest.

28. The inspection apparatus of claim 26, further comprising a display coupled to the video recorder for displaying the video data received from the video camera.

29. The inspection apparatus of claim 28, further comprising an interface device adapted to be controlled by an operator and to provide control signals indicative of operator control.

30. The inspection apparatus of claim 18, in combination with the surface of interest.

31. The combination of claim 30, wherein the surface of interest is an inside surface of a substantially closed volume.

32. The combination of claim 31, wherein the surface of interest is a tank.

33. The combination of claim 31, wherein access to the inside of the volume is permitted through at least one entry point.

34. The combination of claim 33, wherein the data collection equipment further includes a stalk having the video camera coupled to a first end of the stalk, the stalk comprising:
means for securing the stalk to the at least one entry point, such that the first end of the stalk is inside the volume.

35. The combination of claim 34, further comprising means for positioning the camera in a known reference position with respect to the volume.

36. The inspection apparatus of claim 12, wherein the data collection equipment is adapted to be submersed in a fluid.

37. The inspection apparatus of claim 36, wherein the data collection equipment includes locomotion means adapted to navigate the data collection equipment through the fluid.

38. A method of inspecting a surface of interest, the method comprising acts of:
automatically applying a sequence of camera control parameters to acquire a sequence of images of the surface of interest; and
automatically processing the sequence of images to evaluate the surface of interest to provide an inspection result.

39. The method of claim 38, wherein the act of applying the sequence of camera control parameters includes an act of applying a sequence of camera control parameters having resulted at least in part from a manual inspection of the surface of interest.

40. The method of claim 38, wherein the act of applying the sequence of camera control parameters includes an act of applying a sequence of camera control parameters having resulted at least in part from operator programming.

41. The method of claim 38, wherein the act of automatically processing the sequence of images includes an act of automatically determining the amount of subject matter of interest present in the sequence of images.

42. The method of claim 41, wherein the act of automatically determining the amount of subject matter of interest includes an act of automatically detecting characteristic features of the subject matter of interest.

43. The method of claim 42, wherein the act of automatically detecting characteristic features of the subject matter of interest includes an act of automatically detecting edge characteristics of the subject matter of interest.

44. The method of claim 43, wherein that act of automatically detecting edge characteristics includes an act of automatically detecting edge characteristics based on at least one of edge strength, edge cluster size, and edge cluster eccentricity.

45. The method of claim 44, wherein the act of automatically detecting edge characteristics includes an act of evaluating an edge cluster based on at least one of the mean greyscale value of the edge cluster and the standard deviation of the greyscale values of the edge cluster.

46. An automated inspection apparatus comprising:
means for automatically acquiring at least one sequence of images of a surface of interest from a sequence of camera control parameters; and
means for automatically processing the at least one sequence of images to automatically evaluate the surface of interest to provide an inspection result.

47. The automated inspection system of claim 46, wherein the means for automatically acquiring at least one sequence comprises:
a video camera;
a processor coupled to the video camera via communications means; and
a memory accessible by the processor having stored thereon a sequence of camera control parameters associated with a plurality of poses of the camera that when applied to the camera by the processor results in the at least one sequence of images.

48. The automated inspection system of claim 46, wherein the means for automatically processing the at least one sequence of images includes a processor and a memory accessible by the processor having encoded thereon at least one program that when executed by the processor assesses each image in the at least one sequence of images such that the amount of subject matter of interest in each image is determined.
